(19) United States
(12) Patent Application Publication
(10) Pub. No.: US 2013/0218483 A1
(43) Pub. Date: Aug. 22, 2013

(54) COOLING TOWER DRAIN MONITOR

(71) Applicant: Carl Sawyer, Tyrone, GA (US)

(72) Inventor: Carl Sawyer, Tyrone, GA (US)

(73) Assignee: Johnson Controls Technology Company

(21) Appl. No.: 13/399,944

(22) Filed: Feb. 17, 2012

(51) Int. Cl. G06F 19/00

(52) U.S. Cl. 702/35

(57) ABSTRACT

An apparatus for detecting an operating fault in a cooling tower system includes a sensor positioned in a drain of the cooling tower system. The sensor is configured to sense a characteristic of water flowing through the drain. The apparatus also includes a processing device electrically coupled to the sensor. The processing device is configured to quantify a drain water value based on the characteristic detected. The processing device is further configured to initiate an alarm if the quantified drain water value exceeds a pre-specified value.

### BACKGROUND

Cooling towers play a critical role in efficiently removing heat from large buildings, power plants, and other facilities. These systems are generally reliable, but compromised operating conditions may persist in cooling tower systems undetected. Such conditions may result in large amounts of water wasting, particularly wasting of potable or other useable and valuable water.

Many large cooling tower systems include multiple cooling towers or multiple cells, which may be linked to a common heat generating source. The cooling tower system typically circulates water between the towers or cells and the heat generating source to remove the waste heat or cool the heat generating source. Through the cooling process, the level of concentration of minerals in the circulated water may increase because the amount of water decreases during the heat removal process. Because an increase in concentration of minerals may foul and corrode various components in the system, water may be intentionally removed from the system to maintain the proper chemical balance or mineral concentration level of the circulated water. The removed water is referred to as “blow-down” or “draw-off” or “bleed” water. Additionally, water with a lower concentration level of minerals is typically added to the circulated water after a number of cycles through the system to maintain a desired chemical balance, mineral concentration level, and water volume. The added water is referred to as “make-up” water. Make-up water may be added to each tower. The overall level in the basin or reservoir of a cooling tower is generally controlled by a water level device. When water is needed, a valve is opened to supply fresh make-up water.

If there is a failure in a component of the system, for example, if the water level device is experiencing a mechanical malfunction, the system may cause unwarranted “make-up” water to flow into the basin of one or more cells. Such failures are not easily detected and may persist over an extended period of time before being corrected.

### SUMMARY

A reliable fault detection system may be generated by monitoring activity in the drain of one or more cells of a cooling tower system. The flow activity in the drain may be monitored and characterized to signal when an operational fault is occurring in the system, which fault may be causing excessive consumption of valuable water and the associated chemicals used to sanitize that water. In view of the foregoing, the present disclosure is directed to apparatuses and methods for detecting operational faults in a component of a cooling tower system by monitoring drain activity.

In some exemplary inventive embodiments disclosed herein, an apparatus for detecting an operating fault in a cooling tower system includes a sensor positioned in a drain of the cooling tower system. The sensor is configured to sense at least one characteristic of (or associated with) water flowing through the drain. The apparatus further includes a processing device electrically coupled to the at least one sensor. The processing device is configured to quantify a drain water value based on the sensed characteristic. The processing device is also configured to initiate an alarm if the quantified drain water value exceeds a pre-specified value.

The quantified drain water value may be a flow-rate in accordance with various inventive embodiments. The flow rate may be used by the processing device to determine a drain volume. The quantified drain water value may be flow duration, in accordance with some inventive embodiments. The quantified drain water value may be periodically updated by the processing device.

In accordance with related inventive embodiments, the sensor may include a flow-valve.

The apparatus may include at least one sensor positioned in a hot water entry pipe coupled to an entry port of at least one cell in the cooling tower system. The sensor positioned in the hot water entry pipe may be electrically coupled to the processing device and the sensor in the hot water entry pipe may be configured to detect at least one characteristic of water flowing through the hot water entry pipe. The processing device may be configured to quantify a hot water value based on the detected characteristic of water flowing through the hot water entry pipe and may be configured to compare the hot water value to the drain water value.

In other related inventive embodiments, the apparatus may include a sensor positioned in a make-up water entry pipe coupled to a make-up water entry port of at least one cell in the cooling tower system. The sensor positioned in the make-up water entry pipe may be electrically coupled to the processing device and the sensor positioned in the make-up water entry pipe may be configured to detect at least one characteristic of water flowing through the make-up water entry pipe. The processing device may be configured to quantify a make-up water value based on the detected characteristic of water flowing through the make-up entry pipe, and the processing device may be further configured to compare the make-up water value to the drain water value.

In one inventive embodiment, the pre-specified value is selected to correspond to a water flow-rate that exceeds the flow-rate of the make-up water flow-rate. In another inventive embodiment, the quantified drain water value is temperature.

Another inventive embodiment provides an apparatus for detecting an operating fault in a cooling tower system that includes a sensor positioned in a drain of the cooling tower system, which sensor is configured to detect at least one chemical characteristic of water flowing through the drain. The apparatus also includes a processing device electrically coupled to the sensor. The processing device is configured to initiate an alarm if the sensor detects a chemical characteristic that exceeds or falls below a pre-specified range for the chemical characteristic. The chemical characteristic may by pH or a salt concentration level. The chemical characteristic may sense the concentration level of any chemical cleaning, sanitizing, or purifying agent added to the water.

Another inventive embodiment provides a method of detecting an operating fault in a cooling tower system. The method includes detecting, via a sensor positioned in a drain of the cooling tower system, at least one characteristic of water flowing through the drain. The method further includes quantifying, via a processing device electrically coupled to the sensor, a drain water value based on the characteristic detected by the sensor. The method also includes transmitting an alarm indicator if the quantified drain water value exceeds a pre-specified value. The quantified drain water value may be flow-rate or flow duration, in various inventive embodiments. The quantified drain water value may include a concentration level of a chemical flowing through the drain. The quantified drain water value may include a measured pH value.

In related inventive embodiments, the method may include quantifying a drain volume over a pre-specified period of time.

The method may include causing the closing of a valve introducing make-up water into at least one cell of the cooling tower system, in some inventive embodiments.

In various other inventive embodiments, the method may include activating the sensor in conjunction with opening a blow-down valve, the blow-down valve permitting water to flow from at least one cell in the cooling tower system into the drain.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 illustrates an exemplary cooling tower system coupled to an apparatus for detecting an operating fault in a cooling tower system, according to one inventive embodiment.

FIG. 2 provides a block diagram demonstrating the operational phases of an apparatus for detecting an operating fault in a cooling tower system, in accordance with an inventive embodiment.

FIG. 3 provides a flow-chart illustrating the steps of a control system of an apparatus for detecting an operating fault in a cooling tower system, in accordance with an inventive embodiment.

FIG. 4 illustrates an exemplary cooling tower system including a plurality of cells coupled to an apparatus for detecting an operating fault in a cooling tower system, according to one inventive embodiment.

The features and advantages of the inventive concepts disclosed herein will become more apparent from the detailed description set forth below when taken in conjunction with the drawings.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Various inventive embodiments disclosed herein are directed generally to apparatuses and methods for detecting an operating fault in a cooling tower system. The inventive embodiments achieve this functionality by monitoring flow activities in the drain system of the cooling tower system or the drain of a cell in the cooling tower system. The system identifies and quantifies a flow characteristic associated with water flowing through the drain of the cooling tower. The drain as used herein may include the entry port into the drain or any region in the drain pipe. The drain water refers to water that is removed from the circulation path between a cooling tower or cell within the system and the component introducing waste heat into the circulating cooling water or fluid.

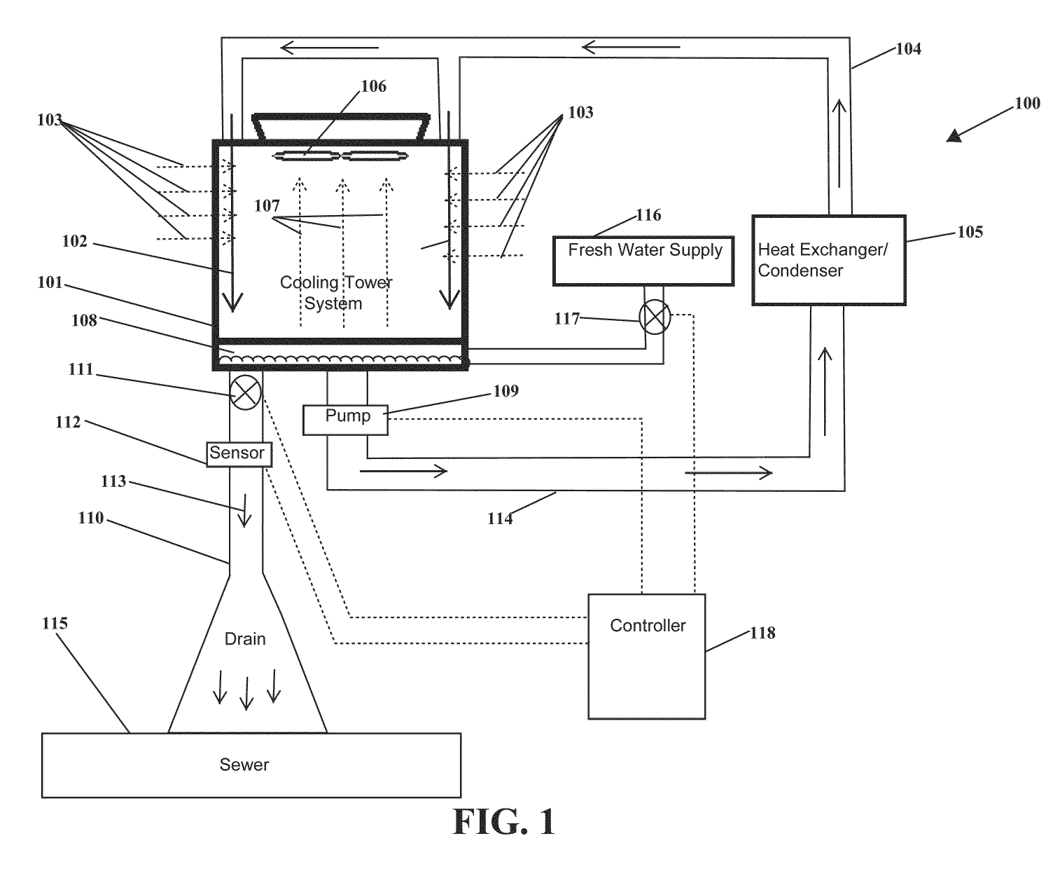

FIG. 1 illustrates an exemplary cooling tower system coupled to an apparatus for detecting an operating fault in a cooling tower system, according to one inventive embodiment. Cooling tower 101 is an exemplary cell of a cooling tower system. Cooling tower 101 demonstrates an induced draft cross-flow cooling tower. However inventive embodiments of the fault detecting apparatus disclosed herein may be used with various cooling tower configurations including induced draft counter-flow towers and cooling towers with fill components, louvers, hot water sprayers, etc. Hot water 102 is introduced into the cooling tower via the hot water entry pipes 104. Pipes 104 bring hot water from a component being cooled, such as an HVAC (heating, ventilating, and air conditioning) system, a power generation component, or any other system generating waste heat, represented generally as heat exchanger/condenser 105 in FIG. 1. A recirculation pump 109 may be implemented with the cooling tower system to keep the water circulating through the system between the cooling tower 101 and the heat exchanger 105. The cooling tower 101 and heat exchanger 105 may be remotely located with respect to one another in a building or facility and may be connected merely by the requisite hot water and cold water piping, 104 and 114 respectively.

Once hot water 102 enters the cooling tower 101, the water will interact with air 103 typically provided at the ambient temperature of the environment. The flow of air 103 into the cooling tower from the environment may be induced by a fan at the discharge opening of the cooling tower, may be forced by a fan sucking air into the tower and blowing it through the tower, or it may simply be a natural draft that utilizes the buoyancy of warmer air to generate an air current in the system based on the pressure difference in the cold air outside and the air warmed in the tower. As demonstrated in FIG. 1, exemplary cooling tower 101 uses an induced draft created by fan 106. Once ambient air 103 enters the tower (through louvers or other openings and contacts hot water 102, the warmed air 107 will rise out of the cooling tower. As the ambient air absorbs heat from hot water 102 and is transformed into warm air 107, the hot water 102 is cooled and is collected in a basin or reservoir 108, generally located in the base of cooling tower 101. The cooled water in basin 108 is then circulated back to the heat exchanger 105 via pump 109 and cold water recirculation pipe 114.

As discussed above, through this process some of the water, which may include other fluids to enhance its absorbency, may be lost through evaporation when cross-flowed with the ambient air. This reduction in the volume of water causes concentration levels of mineral contained therein to be increased in the circulating fluids. Because the increased concentration level in the re-circulating water can cause damage to various components in the system and may provide a breeding ground for bacteria, the water may be circulated a limited number of times before being altered by one or both of the addition of water (make-up) and or sanitization chemicals and by the removal of water at high mineral concentration levels (drain-off). The interplay of water removal and water addition can strike a delicate and complicated balance, which may become even more complicated when there are a number of cooling towers receiving make-up water via the commands of a level indicator positioned in one of the plurality of cooling towers. Mechanical failures, such as failure of the level indicator, drain or make-up valve failures, pump failures, etc. may also contribute to a fault in the cooling tower systems and as noted above, such a fault due to a mechanical, electrical, electro-mechanical, or chemical failure may not be readily apparent. Since these failures may easily go unnoticed for a particularly long time, for example between regularly scheduled maintenance, they provide ample periods for the loss of large amounts of clean water and the associated chemicals used therein. Inventive embodiments disclosed herein generate alarms to provide an indication of such failures and thereby reduce the noted loses and increase system efficiency.

As further demonstrated in FIG. 1, an exemplary embodiment includes a sensor 112 positioned in drain 110 for cooling tower 102. Sensor 112 may be positioned at any point in the drain suitable for sensing the desired characteristic. Drain 110 may include a drain valve 111 in some embodiments. In some embodiments valve 111 may only be opened at specific intervals or pursuant to commands from controller 118. In some embodiments, sensor 112 may be integral with valve 111. In some embodiments, drain 110 may not include a valve, but may simply be a passive drain, provided to accept overflow from basin 108. In embodiments where the drain is a passive drain without a valve, the drain may simply include sensor 112 positioned therein. In various embodiments, sensor 112 may be a flow sensor designed to sense water flow in drain 110. Sensor 112 is connected to a controller or control panel 118 in accordance with inventive embodiments. Controller 118 may initiate an alarm if sensor 112 senses fluid flow over a period exceeding a pre-specified period. The alarm may be indicative of a component malfunction. For example, if a level indicator (mechanical or electrical) in basin 108 erroneously indicates that the water level in basin 108 is low, the low level indication may initiate an introduction of fresh water into basin 108 as make-up water via fresh water supply 116 and an opening of valve 117 between supply 116 and the cooling tower 101 until water begins overflowing from the basin and begins leaving the circuit via drain 110. Accordingly, the fresh water supply, which may input water from a municipal facility, a fresh water source such as a pond river, or aquifer, or an onsite water treatment facility will unnecessarily continue pumping fresh water into the system until the malfunction in the water level device is fixed. As such, sensor 112 may be configured to signal the water flow into the drain 110 and if controller 118 receives a water flow-signal from sensor 112 for an extended period an alarm may be initiated. The water directed or allowed to flow into drain 110 may flow into a sewer system 115 for further processing and treatment. In other embodiments, sensor 112 may be configured to measure an actual flow rate.

In certain embodiments, sensor 112 may sense a characteristic of drain-off water inadvertently or intentionally introduced into drain 110. The sensor may sense for example the mineral concentration level or the pH of the water being drained from the system. In a system that is working well and that is running optimally and efficiently, water purposefully drained from a cell will have a high mineral concentration or total dissolved solids (TDS) level. The TDS level of the water drained off will generally be at a level that is significantly higher than potable water because of the water reduction achieved when the water is cooled via ambient air. As such, the sensor in the drain may be implemented to monitor and increase the efficiency of the system. If for example water was being drained-off with a mineral concentration level close to that of potable water or that was not significantly higher than potable water, which typically has a level of 100 to 350 parts per million, the drain sensor could identify this low concentration level, particularly in a system that is passively set to circulate the water for a certain period or a certain number of times before refreshing with make-up water and reducing draw-off water, and provide an alarm indicative of the inefficiency in the system. This may additionally halt further introduction of make-up water until the cooling tower system is checked and the alarm indicator reset. In addition to being configured to monitor the TDS level or the pH level, the chemical sensor may be configured to detect other specific chemical compositions in the water such as chemicals added to the water for sanitization.

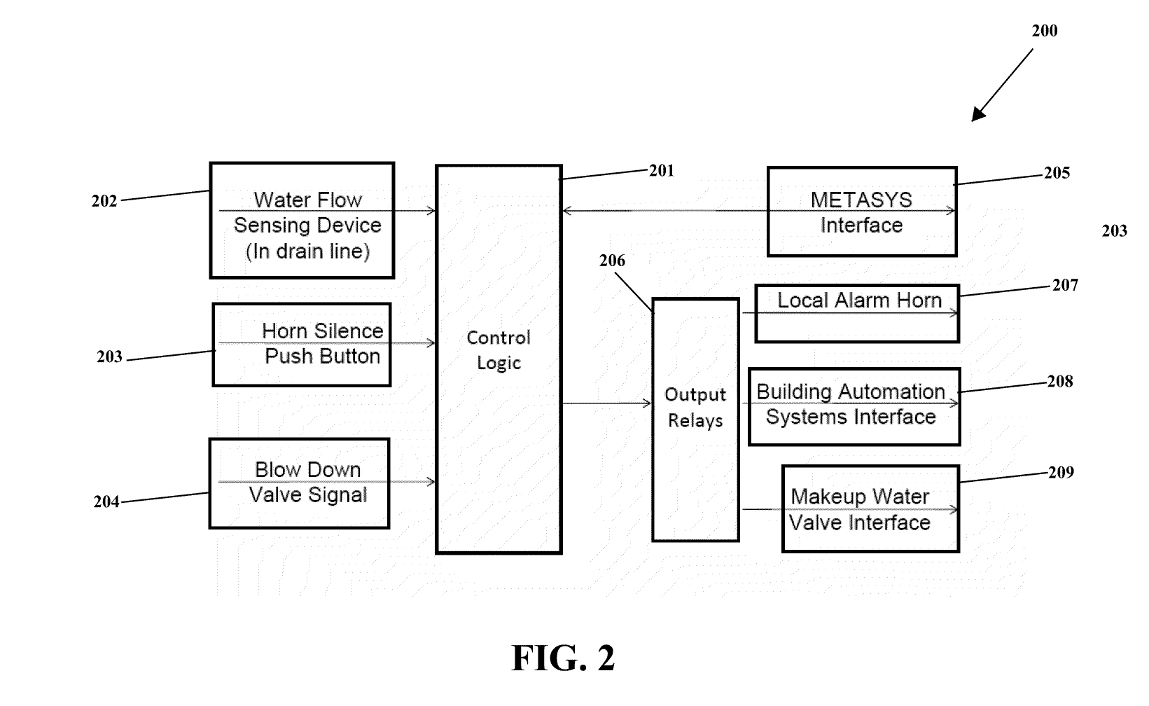

FIG. 2 provides a block diagram demonstrating the operational phases of an apparatus for detecting an operating fault in a cooling tower system, in accordance with an exemplary embodiment. FIG. 2 demonstrates a control logic component 201 which may be implemented in or by controller 118 in FIG. 1. The control logic is electrically coupled to the water flow sensing device 202 positioned in the drain of the cooling tower system. Sensor 202 may be coupled to control logic via a wired connection or may include a transmitter for wirelessly connecting with the control logic system 201. The control 201 may be further coupled to a horn silence push button 203, to allow the local alarm horn 207 activatable by the control logic 201 via relay output 206, to be reset if an alarm condition has been rectified or is being investigated. The controller may be further connected to a blow down valve signal controller 204. The controller may be configured to receive inputs from the blow down valve and may also be configured to implement some automatic actions through the blow down valve signal controller 204 under an alarm condition, such as closing the valve to prevent continued water losses.

The control logic 201 may be incorporated into a control and automation system for a building such as the METASYS brand building management system provided by Johnson Controls. Accordingly, the control system may be integrated with the primary control system of an entire building. Control logic 201 may be connected to send information to various other components of the cooling tower system or of the facilities of a site or building at which the cooling tower system is implemented. For example, the control may provide information to another building automation system interface 208, the controller of other building components, and may provide output signals to one or more make-up water valve interfaces 209, to cause a decrease or cessation in the introduction of water into the system or to cause an increase or initiation in the introduction of water into the cooling tower system water circuit.

In some embodiments, logic 201 may be coupled to at least one sensor positioned in a hot water entry pipe coupled to an entry port of at least one cell in the cooling tower system. The sensor positioned in the hot water entry pipe may be configured to detect at least one characteristic of water flowing through the hot water entry pipe. Logic 201 may be configured to quantify a hot water value based on the detected characteristic of water flowing through the hot water entry pipe and may be further configured to compare the hot water value to the drain water value. Similarly, in some embodiments, logic 201 may be coupled to at least one sensor positioned in a make-up water entry pipe coupled to an entry port into the water basin of at least one cell in the cooling tower system. The sensor positioned in the make-up water entry pipe may be configured to detect at least one characteristic of water flowing through the make-up water entry pipe. Logic 201 may be configured to quantify a make-up water value based on the detected characteristic of water flowing through the make-up water entry pipe and may be further configured to compare the make-up water value to the drain water value.

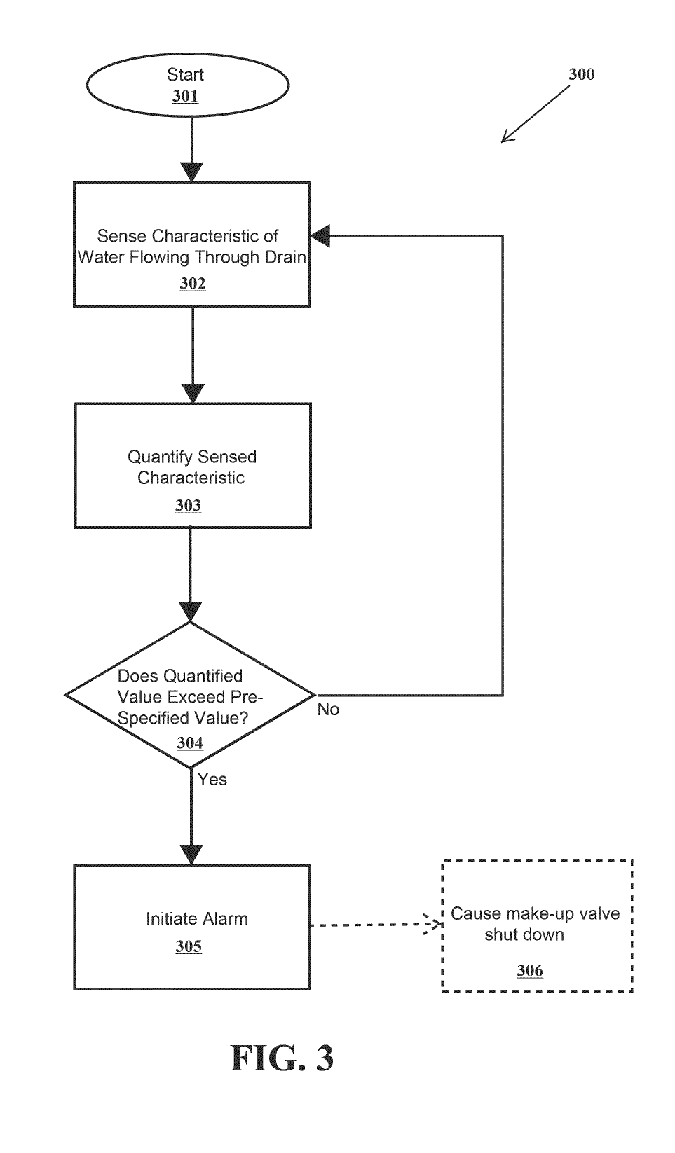

FIG. 3 provides a flow-chart illustrating the steps of a control system of an apparatus for detecting an operating fault in a cooling tower system, in accordance with an exemplary embodiment. The flow-chart demonstrates the steps that may be engaged by control logic 201 of FIG. 2 in controller 118 of FIG. 1. Once the logic initiates in step 301, it receives input from the sensor positioned in the drain in a first process step 302. Receipt of this input could be initiated by the activation of the sensor, which activation might be triggered by water flow in the drain. In some embodiments, the control logic may be configured to poll the drain sensor at regular pre-set intervals in order to receive input from the sensor in step 302. Once a signal is received from the sensor, the control logic will proceed to quantify the sensed characteristic in process step 303. This quantification may quantify the duration that the sensor has sensed a particular condition, the volume of flow, the flow-rate, or a concentration level. The control logic will be programmed with the appropriate algorithm or software and other related information to achieve the requisite quantification. Once the sensed characteristic is quantified the logic will generally complete a comparison or make a determination of whether or not the quantified sensed characteristic exceeds a pre-specified value, or is outside of (above or below) a pre-specified range. If the quantified value exceeds a value, as determined in process step 304, the logic proceeds to initiate an alarm or indication of the detected fault condition in process step 305. If the value does not exceed a pre-specified value or fails to fall outside of a pre-specified range (or is above a specified value in a minimum value configuration), the logic will not initiate an alarm, but will instead continue to monitor either via an automatic polling or at the activation of the sensor for a subsequent quantification. As demonstrated in FIG. 3, if the alarm condition is present and initiates an alarm, the control logic may also output a signal in process step 306 to cause an operational change, such as causing a shut-down in the make-up valve to prevent further unnecessary flow of fresh water into the system.

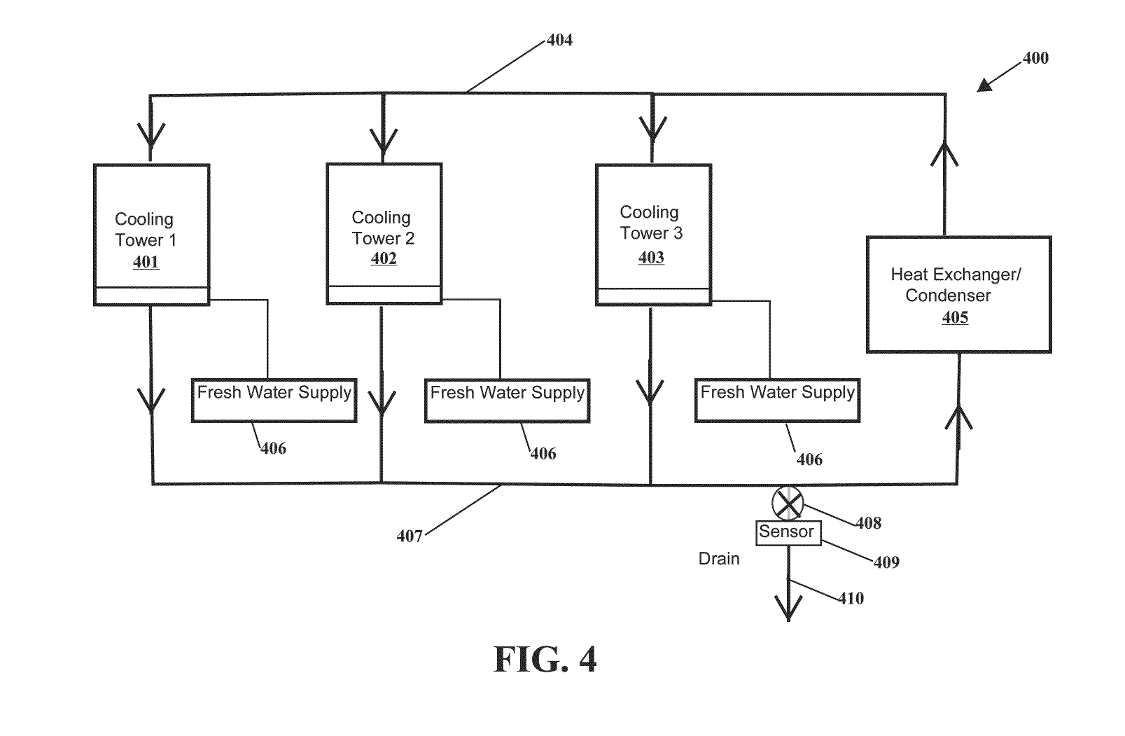

FIG. 4 illustrates an exemplary cooling tower system including a plurality of cells coupled to an apparatus for detecting an operating fault in a cooling tower system, according to one inventive embodiment. The system depicted in FIG. 4 operates in the same manner as the aforementioned system, but demonstrates that a single sensor 409 may be implemented in drain 410 to provide alarm indications based on drain water characteristics sensed therein. In such an embodiment, a plurality of cooling towers, 401-403 may be set up to drain into a common drain. Each tower 401-403 may receive hot water 404 from one or more heat exchangers 405 and while each may include a local drain, the totality of drains may be coupled via pipe 407 to flow into a common drain 410 which may include a drain valve 408. Each of the cooling towers 401-403 may be coupled to a fresh water supply 406. In other inventive embodiments, a drain sensor may be provided in the drain of each cooling tower and each of the sensors may be coupled to a common controller.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described inventive embodiments can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An apparatus for detecting an operating fault in a cooling tower system, the apparatus comprising:
a sensor positioned in a drain of the cooling tower system, the sensor configured to sense at least one characteristic of water flowing through the drain; and
a processing device electrically coupled to the sensor, the processing device configured to quantify a drain water value based on the characteristic detected and to initiate an alarm if the quantified drain water value exceeds a pre-specified value.

2. The apparatus of claim 1, wherein the quantified drain water value is flow-rate.

3. The apparatus of claim 2, wherein the processor is configured to determine a drain volume based on the flow-rate.

4. The apparatus of claim 1, wherein the quantified drain water value is flow duration.

5. The apparatus of claim 1, wherein the quantified drain water value is periodically updated by the processing device.

6. The apparatus of claim 1, wherein the sensor includes a flow-valve.

7. The apparatus of claim 1, further comprising a second sensor positioned in a hot water entry pipe, the hot water entry pipe coupled to an entry port of a cell in the cooling tower system, the sensor positioned in the hot water entry pipe electrically coupled to the processing device and configured to detect a characteristic of water flowing through the hot water entry pipe,
wherein the processing device is further configured to quantify a hot water value based on the detected characteristic of water flowing through the hot water entry pipe and to compare the hot water value to the drain water value.

8. The apparatus of claim 1, further comprising a second sensor positioned in a make-up water entry pipe, the make-up water entry pipe coupled to a make-up water entry port of a cell in the cooling tower system, the sensor positioned in the make-up water entry pipe electrically coupled to the processing device and configured to detect a characteristic of water flowing through the make-up water entry pipe,
wherein the processing device is further configured to quantify a make-up water value based on the detected characteristic of water flowing through the make-up entry pipe and to compare the make-up water value to the drain water value.

9. The apparatus of claim 1, wherein the pre-specified value is selected to correspond to a water flow-rate that exceeds the flow-rate of the make-up water flow-rate.

10. The apparatus of claim 1, wherein the quantified drain water value is temperature.

11. An apparatus for detecting an operating fault in a cooling tower system, the apparatus comprising:
a sensor positioned in a drain of the cooling tower system, the sensor configured to detect a chemical characteristic of water flowing through the drain; and
a processing device electrically coupled to the sensor, the processing device configured to initiate an alarm if the sensor detects a chemical characteristic that exceeds or falls below a pre-specified range for the chemical characteristic.

12. The apparatus of claim 11, wherein the chemical characteristic is pH.

13. The apparatus of claim 11, wherein the chemical characteristic is a salt concentration level.

14. A method of detecting an operating fault in a cooling tower system, the method comprising:
detecting, via a sensor positioned in a drain of the cooling tower system, a characteristic of water flowing through the drain;
quantifying, via a processing device electrically coupled to the sensor, a drain water value based on the characteristic detected by the sensor
transmitting an alarm indicator if the quantified drain water value exceeds a pre-specified value.

15. The method of claim 14, wherein the quantified drain water value is a flow-rate.

16. The method of claim 14, wherein the quantified drain water value is a flow duration.

17. The method of claim 14, wherein the quantified drain water value is a concentration level of a chemical in the water flowing through the drain.

18. The method of claim 17, wherein the quantified drain water value is pH value.

19. The method of claim 14, further comprising quantifying a drain volume over a period of time.

20. The method of claim 14, further comprising causing the closing of a valve introducing make-up water into a cell of the cooling tower system.

21. The method of claim 14, further comprising activating the sensor in conjunction with opening a blow-down valve, the blow-down valve permitting water to flow from a cell in the cooling tower system into the drain.
